(19) United States
(12) Patent Application Publication
(10) Pub. No.: US 2025/0244266 A1
(43) Pub. Date: Jul. 31, 2025

(54) MEASURING METHOD AND MEASURING DEVICE

(71) Applicant: Japan Display Inc., Tokyo (JP)

(72) Inventors: Kaichi FUKUDA, Tokyo (JP); Satoru TOMITA, Tokyo (JP)

(73) Assignee: Japan Display Inc., Tokyo (JP)

(21) Appl. No.: 19/037,534

(22) Filed: Jan. 27, 2025

(30) Foreign Application Priority Data
Jan. 30, 2024 (JP) 2024-012070

(51) Int. Cl. G01N 23/2251

(52) U.S. Cl. CPC G01N 23/2251; G01N 2223/6113

(57) ABSTRACT

According to one embodiment, a measuring method includes forming a partition including a lower portion provided on a base and an upper portion protruding from a side surface of the lower portion, acquiring a plurality of images generated by detecting secondary electrons that occur by emitting electron beams including primary electrons toward the partition from a plurality of second directions inclined from a first direction orthogonal to the base, analyzing the acquired plurality of images, and measuring a first angle for indicating a ratio of an amount of protrusion at which an end portion of the upper portion protrudes from the side surface of the lower portion to a length of the lower portion in the first direction, based on a result of the analysis.

### CROSS-REFERENCE TO RELATED APPLICATIONS

This application is based upon and claims the benefit of priority from Japanese Patent Application No. 2024-012070, filed Jan. 30, 2024, the entire contents of which are incorporated herein by reference.

### FIELD

Embodiments described herein relate generally to a measuring method and a measuring device.

### BACKGROUND

Recently, display devices with organic light-emitting diodes (OLEDs) applied thereto as display elements have been put into practical use.

Incidentally, the display device described above is manufactured by preparing a motherboard on which a plurality of display panels are formed, and using each of the display panels cut from the motherboard.

A technique of suppressing the reduction in reliability of the display devices has been required in a process of manufacturing the display devices.

### BRIEF DESCRIPTION OF THE DRAWINGS

FIG. 1 is a view showing a configuration example of a display device according to an embodiment.

FIG. 2 is a diagram showing an example of the layout of subpixels.

FIG. 3 is a schematic cross-sectional view showing the display device along III-III line in FIG. 2.

FIG. 4 is a schematic cross-sectional view of a partition.

FIG. 5 is a schematic cross-sectional view illustrating a display element formed using a partition.

FIG. 6 is a schematic cross-sectional view illustrating the display element formed using the partition.

FIG. 7 is a schematic cross-sectional view illustrating the display element formed using the partition.

FIG. 8 is a view illustrating a relationship between an amount of protrusion of the partition and a height of a lower portion.

FIG. 9 is a view illustrating a motherboard inspection device used in a display device manufacturing process.

FIG. 10 is a view illustrating a configuration of SEM.

FIG. 11 is a view illustrating an example of a target angle to be measured in the embodiment.

FIG. 12 is a view showing an example of a hardware configuration of a measuring device.

FIG. 13 is a view showing an example of a functional configuration of the measuring device.

FIG. 14 is a flowchart showing an example of a procedure of the measuring device.

FIG. 15 is a view illustrating an example of a process of measuring a target angle.

FIG. 16 is a view illustrating an example of a process of measuring a target angle.

FIG. 17 is a view illustrating another example of a process of measuring a target angle.

FIG. 18 is a view illustrating yet another example of a process of measuring a target angle.

FIG. 19 is a view illustrating another example of a target angle to be measured in the embodiment.

### DETAILED DESCRIPTION

In general, according to one embodiment, there is provided a measuring method including forming a partition including a lower portion provided on a base and an upper portion protruding from a side surface of the lower portion, acquiring a plurality of images generated by detecting secondary electrons that occur by emitting electron beams including primary electrons toward the partition from a plurality of second directions inclined from a first direction orthogonal to the base, analyzing the acquired plurality of images, and measuring a first angle for indicating a ratio of an amount of protrusion at which an end portion of the upper portion protrudes from the side surface of the lower portion to a length of the lower portion in the first direction, based on a result of the analysis.

An embodiment will be described hereinafter with reference to the accompanying drawings.

The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Furthermore, in the description and figures of the present application, structural elements having the same or similar functions will be referred to by the same reference numbers and detailed explanations of them that are considered redundant may be omitted.

In the figures, an X-axis, a Y-axis and a Z-axis orthogonal to each other are described to facilitate understanding as needed. A direction along the X-axis is referred to as a direction X, a direction along the Y-axis is referred to as a direction Y, and a direction along the Z-axis is referred to as a direction Z. In addition, viewing various elements parallel to the direction Z is referred to as plan view.

The display device of the embodiment is an organic electroluminescent display device including an organic light emitting diode (OLED) as a display element (light emitting element), and can be mounted on televisions, personal computers, vehicle-mounted devices, tablet terminals, smartphones, cellphone terminals, and the like.

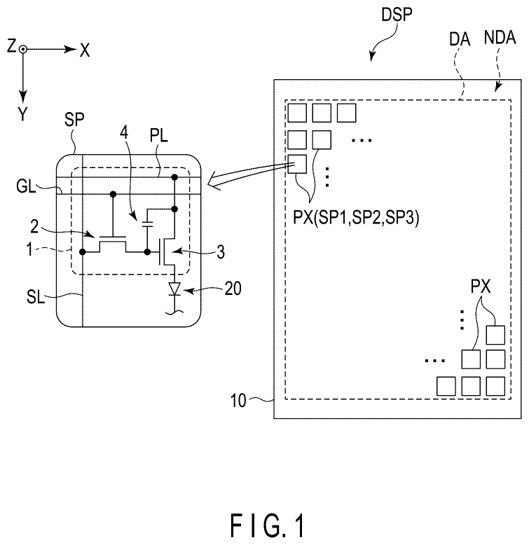

FIG. 1 is a view showing a configuration example of a display device DSP according to the embodiment. The display device DSP has a display area DA where images are displayed and a non-display area NDA around the display area DA, on an insulating base 10. The base 10 may be glass or a flexible resin film.

In the embodiment, the shape of the base 10 in plan view is a rectangular shape. However, the shape of the base 10 in plan view is not limited to a rectangular shape, but may also be other shape such as a square, a circle or an ellipse.

The display area DA includes a plurality of pixels PX arrayed in a matrix in the direction X and the direction Y. Each of the pixels PX includes a plurality of subpixels SP. As an example, the pixel PX includes a red subpixel SP1, a green subpixel SP2, and a blue subpixel SP3. Incidentally, the pixel PX may include a subpixel SP of the other color such as white, together with the subpixels SP1, SP2, and SP3. In addition, the pixel PX may include a subpixel SP of the other color instead of any of the subpixels SP1, SP2, and SP3.

The subpixel SP includes a pixel circuit 1 and a display element 20 driven by the pixel circuit 1. The pixel circuit 1 includes a pixel switch 2, a drive transistor 3, and a capacitor 4. The pixel switch 2 and the drive transistor 3 are, for example, switching elements constituted by thin-film transistors.

A gate electrode of the pixel switch 2 is connected to a scanning line GL. Either of a source electrode and a drain electrode of the pixel switch 2 is connected to a signal line SL, and the other is connected to a gate electrode of the drive transistor 3, and the capacitor 4. Either of the source electrode and the drain electrode of the drive transistor 3 is connected to a power line PL and the capacitor 4, and the other is connected to the display element 20.

Incidentally, the configuration of the pixel circuit 1 is not limited to the example shown in FIG. 1. For example, the pixel circuit 1 may include more thin-film transistors and more capacitors.

The display element 20 includes an organic light emitting diode (light emitting element). For example, the subpixel SP1 includes a display element 20 that emits light of a red wavelength range, the subpixel SP2 includes a display element 20 that emits light of a green wavelength range, and the subpixel SP3 includes a display element 20 that emits light of a blue wavelength range.

Incidentally, FIG. 1 mainly shows a display panel used for manufacturing the display device DSP, and the display device DSP has a structure in which a circuit board or the like including a driver (driver IC chip) which drives the display panel is connected to the display panel.

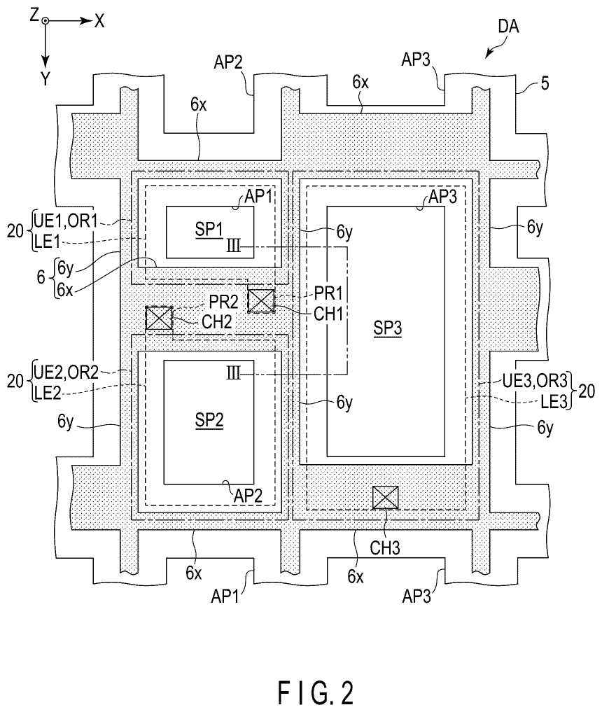

FIG. 2 shows an example of a layout of the subpixels SP1, SP2, and SP3. In the example shown in FIG. 2, the subpixels SP1 and SP2 are aligned in the direction Y. Furthermore, each of the subpixels SP1 and SP2 is arranged with the subpixel SP3 in the direction X.

When the subpixels SP1, SP2, and SP3 are arranged in the layout shown in FIG. 2, a row in which the subpixels SP1 and SP2 are alternately arranged in the direction Y and a row in which a plurality of subpixels SP3 are repeatedly arranged in the direction Y are formed in the display area DA. These rows are alternately arranged in the direction X.

The layout of the subpixels SP1, SP2, and SP3 is not limited to the example in FIG. 2. As another example, the subpixels SP1, SP2, and SP3 in each pixel PX may be arranged in order in the direction X.

A rib 5 and a partition 6 are arranged in the display area DA. The rib 5 includes apertures AP1, AP2, and AP3 in the subpixels SP1, SP2, and SP3, respectively. In the example shown in FIG. 2, the aperture AP2 is larger than the aperture AP1, and the aperture AP3 is larger than the aperture AP2. The partition 6 is provided on a boundary between adjacent subpixels SP and overlaps with the rib 5 in plan view.

The partition 6 includes a plurality of first partitions 6x extending in the direction X and a plurality of second partitions 6y extending in the direction Y. The plurality of first partitions 6x are arranged between the aperture AP1 and the aperture AP2 adjacent in the direction Y and between two apertures AP3 adjacent in the direction Y. The second partitions 6y are arranged between the aperture AP1 and the aperture AP3 adjacent in the direction X and between the aperture AP2 and the aperture AP3 adjacent in the direction X.

In the example in FIG. 2, the first partitions 6x and the second partitions 6y are connected to each other. Thus, the partition 6 has a grating pattern surrounding the apertures AP1, AP2, and AP3 as a whole. The partition 6 is considered to include apertures at the subpixels SP1, SP2, and SP3, similarly to the rib 5.

In other words, in the embodiment, the rib 5 and the partition 6 are arranged to divide the subpixels SP1, SP2, and SP3.

The subpixel SP1 includes a lower electrode LE1, an upper electrode UE1, and an organic layer OR1 each overlapping with the aperture AP1. The subpixel SP2 includes a lower electrode LE2, an upper electrode UE2, and an organic layer OR2 each overlapping with the aperture AP2. The subpixel SP3 includes a lower electrode LE3, an upper electrode UE3, and an organic layer OR3 each overlapping with the aperture AP3. In the example shown in FIG. 2, outer shapes of the upper electrode UE1 and the organic layer OR1 correspond to each other, outer shapes of the upper electrode UE2 and the organic layer OR2 correspond to each other, and outer shapes of the upper electrode UE3 and the organic layer OR3 correspond to each other.

The lower electrode LE1, the upper electrode UE1, and the organic layer OR1 constitute the display element 20 of the subpixel SP1. The lower electrode LE2, the upper electrode UE2, and the organic layer OR2 constitute the display element 20 of the subpixel SP2. The lower electrode LE3, the upper electrode UE3, and the organic layer OR3 constitute the display element 20 of the subpixel SP3.

The lower electrode LE1 is connected to the pixel circuit 1 which drives (the display element 20 of) the subpixel SP1 through a contact hole CH1. The lower electrode LE2 is connected to the pixel circuit 1 which drives (the display element 20 of) the subpixel SP2 through a contact hole CH2. The lower electrode LE3 is connected to the pixel circuit 1 which drives (the display element 20 of) the subpixel SP3 through a contact hole CH3.

In the example of FIG. 2, the contact holes CH1 and CH2 entirely overlap with the first partition 6x between the aperture AP1 and the aperture AP2 adjacent to each other in the direction Y. The contact hole CH3 entirely overlaps with the first partition 6x between two apertures AP3 adjacent in the direction Y. As an alternative example, at least parts of the contact holes CH1, CH2, and CH3 may not overlap with the first partition 6x.

In the example shown in FIG. 2, the lower electrodes LE1 and LE2 include protrusions PR1 and PR2, respectively. The protrusion PR1 protrudes from the body of the lower electrode LE1 (the portion overlapping with the aperture AP1) toward the contact hole CH1. The protrusion PR2 protrudes from the body of the lower electrode LE2 (the portion overlapping with the aperture AP2) toward the contact hole CH2. The contact holes CH1 and CH2 overlap with the protrusions PR1 and PR2, respectively.

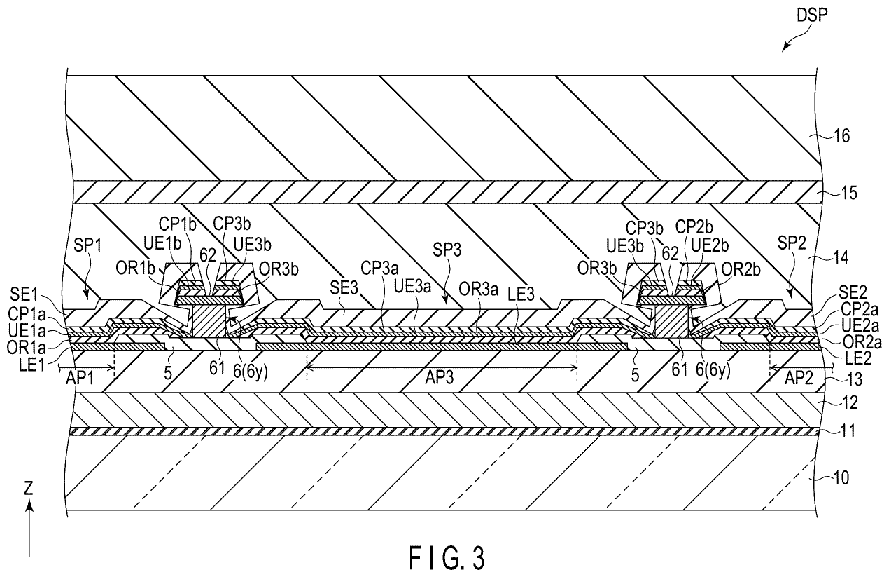

FIG. 3 is a schematic cross-sectional view showing the display device DSP taken along the III-III line in FIG. 2. In the display device DSP, an insulating layer 11 referred to as an undercoat layer is arranged on the base 10 (i.e., on the surface of the side where the display element 20 and the like are arranged).

The insulating layer 11 has, for example, a three-layer stacked structure with a silicon oxide film (SiO), a silicon nitride film (SiN), and a silicon oxide film (SiO). The insulating layer 11 is not limited to the three-layer stacked structure, but may have a stacked structure with more than three layers, or may have a single-layer structure or a two-layer stacked structure.

A circuit layer 12 is arranged on the insulating layer 11. The circuit layer 12 includes various circuits and wires that drive the subpixels SP (SP1, SP2 and SP3) of the pixel circuit 1, the scanning line GL, the signal line SL, the power line PL, and the like shown in FIG. 1. The circuit layer 12 is covered with an insulating layer 13.

The insulating layer 13 functions as a planarization film which planarizes uneven parts generated by the circuit layer 12. Although not shown in FIG. 3, the above-described contact holes CH1, CH2, and CH3 are provided in the insulating layer 13.

The lower electrodes LE (LE1, LE2, and LE3) are arranged on the insulating layer 13. The rib 5 is arranged on the insulating layer 13 and the lower electrodes LE. Ends (several parts) of the lower electrodes LE are covered with the rib 5.

The partition 6 includes a lower portion 61 arranged on the rib 5 and an upper portion 62 that covers an upper surface of the lower portion 61. The upper portion 62 has a greater width in direction X and direction Y than the lower portion 61. As a result, the partition 6 has a shape in which both ends of the upper portion 62 protrude beyond side surfaces of the lower portion 61. This shape of the partition 6 may be referred to as an overhang shape.

The organic layers OR (OR1, OR2, and OR3) and the upper electrodes UE (UE1, UE2, and UE3) constitute the display element 20 together with the above-described lower electrodes LE (LE1, LE2, and LE3) but, as shown in FIG. 3, the organic layer OR1 includes a first organic layer OR1a and a second organic layer OR1b that are separated from each other. The upper electrode UE1 includes a first upper electrode UE1a and a second upper electrode UE1b that are separated from each other. The first organic layer OR1a is in contact with the lower electrode LE1 through the aperture AP1 and covers a part of the rib 5. The second organic layer OR1b is located on the upper portion 62. The first upper electrode UE1a is opposed to the lower electrode LE1 and covers the first organic layer OR1a. Furthermore, the first upper electrode UE1a is in contact with side surfaces of the lower portion 61. The second upper electrode UE1b is located on this partition 6 and covers the second organic layer OR1b.

In addition, as shown in FIG. 3, the organic layer OR2 includes a first organic layer OR2a and a second organic layer OR2b that are separated from each other. The upper electrode UE2 includes a first upper electrode UE2a and a second upper electrode UE2b that are separated from each other. The first organic layer OR2a is in contact with the lower electrode LE2 through the aperture AP2 and covers a part of the rib 5. The second organic layer OR2b is located on the upper portion 62. The first upper electrode UE2a is opposed to the lower electrode LE2 and covers the first organic layer OR2a. Furthermore, the first upper electrode UE2a is in contact with side surfaces of the lower portion 61. The second upper electrode UE2b is located above the partition 6 and covers the second organic layer OR2b.

In addition, as shown in FIG. 3, the organic layer OR3 includes a first organic layer OR3a and a second organic layer OR3b that are separated from each other. The upper electrode UE3 includes a first upper electrode UE3a and a second upper electrode UE3b that are separated from each other. The first organic layer OR3a is in contact with the lower electrode LE3 through the aperture AP3 and covers a part of the rib 5. The second organic layer OR3b is located on the upper portion 62. The first upper electrode UE3a is opposed to the lower electrode LE3 and covers the first organic layer OR3a. Furthermore, the first upper electrode UE3a is in contact with the side surfaces of the lower portion 61. The second upper electrode UE3b is located above the partition 6 and covers the second organic layer OR3b.

In the example shown in FIG. 3, the subpixels SP1, SP2 and SP3 include cap layers CP1, CP2 and CP3 for adjusting the optical property of the light emitted from light emitting layers of the respective organic layers OR1, OR2 and OR3.

The cap layer CP1 includes a first cap layer CP1a and a second cap layer CP1b that are separated from each other. The first cap layer CP1a is located in the aperture AP1 and is provided on the first upper electrode UE1a. The second cap layer CP1b is located above the partition 6 and is provided on the second upper electrode UE1b.

The cap layer CP2 includes a first cap layer CP2a and a second cap layer CP2b that are separated from each other. The first cap layer CP2a is located in the aperture AP2 and is provided on the first upper electrode UE2a. The second cap layer CP2b is located above the partition 6 and is provided on the second upper electrode UE2b.

The cap layer CP3 includes a first cap layer CP3a and a second cap layer CP3b that are separated from each other. The first cap layer CP3a is located in the aperture AP3 and is provided on the first upper electrode UE3a. The second cap layer CP3b is located above the partition 6 and is provided on the second upper electrode UE3b.

Sealing layers SE1, SE2 and SE3 are provided in the subpixels SP1, SP2 and SP3, respectively. The sealing layer SE1 continuously covers the members of the subpixel SP1 including the first cap layer CP1a, the partition 6, and the second cap layer CP1b. The sealing layer SE2 continuously covers the members of the subpixel SP2 including the first cap layer CP2a, the partition 6, and the second cap layer CP2b. The sealing layer SE3 continuously covers the members of the subpixel SP3 including the first cap layer CP3a, the partition 6, and the second cap layer CP3b.

In the example shown in FIG. 3, the second organic layer OR1b, the second upper electrode UE1b, the second cap layer CP1b, and the sealing layer SE1 on the partition 6 between the subpixels SP1 and SP3 are separated from the second organic layer OR3b, the second upper electrode UE3b, the second cap layer CP3b, and the sealing layer SE3 on the partition 6. In addition, the second organic layer OR2b, the second upper electrode UE2b, the second cap layer CP2b, and the sealing layer SE2 on the partition 6 between the subpixels SP2 and SP3 are separated from the second organic layer OR3b, the second upper electrode UE3b, the second cap layer CP3b, and the sealing layer SE3 on the partition 6.

The sealing layers SE1, SE2 and SE3 are covered with a resin layer 14. The resinous layer 14 is covered with a sealing layer 15. Furthermore, the sealing layer 15 is covered with a resin layer 16.

The insulating layer 13 and the resin layers 14 and 16 are formed of organic materials. The rib 5, and the sealing layers 15 and SE (SE1, SE2 and SE3) are formed of, for example, an inorganic material such as silicon nitride (SiNx).

The lower portion 61 included in the partition 6 is conductive. The upper portion 62 included in the partition 6 may also be conductive. The lower electrode LE may be formed of a transparent conductive oxide such as indium tin oxide (ITO) or may have a stacked structure of a metal material such as silver (Ag) and a conductive oxide. The upper electrode UE is formed of, for example, a metal material such as an alloy (MgAg) of magnesium and silver. The upper electrode UE may be formed of a conductive oxide such as ITO.

When the potential of the lower electrode LE is relatively higher than the potential of the upper electrode UE, the lower electrode corresponds to an anode, and the upper electrode UE corresponds to a cathode. In addition, when the potential of the upper electrode UE is relatively higher than the potential of the lower electrode LE, the upper electrode UE corresponds to an anode, and the lower electrode LE corresponds to a cathode.

The organic layer OR includes a pair of functional layers, and a light emitting layer arranged between these functional layers. As an example, the organic layer OR has a structure in which a hole-injection layer, a hole-transport layer, an electron blocking layer, a light emitting layer, a hole blocking layer, an electron-transport layer, and an electron-injection layer are stacked in this order.

The cap layer CP (CP1, CP2, and CP3) is formed of, for example, a multilayer body of a plurality of transparent thin films. As the plurality of thin films, the multilayer body may include a thin film formed of an inorganic material and a thin film formed of an organic material. These thin films have refractive indices different from each other. The materials of the thin films constituting the multilayer body are different from the materials of the upper electrode UE and are also different from the materials of the sealing layer SE. Incidentally, the cap layer CP may be omitted.

A common voltage is supplied to the partition 6. This common voltage is supplied to each of the upper electrodes UE (first upper electrodes UE1a, UE2a, and UE3a) that are in contact with the side surfaces of the lower portion 61. A pixel voltage is supplied to the lower electrode LE (LE1, LE2, and LE3) through the pixel circuit 1 included in each subpixel SP (SP1, SP2, and SP3).

When a potential difference is formed between the lower electrode LE1 and the upper electrode UE1, the light emitting layer of the first organic layer OR1a emits light of the red wavelength range. When a potential difference is formed between the lower electrode LE2 and the upper electrode UE2, the light emitting layer of the first organic layer OR2a emits light of the green wavelength range. When a potential difference is formed between the lower electrode LE3 and the upper electrode UE3, the light emitting layer of the first organic layer OR3a emits light of the blue wavelength range.

As another example, the light emitting layers of the organic layers OR1, OR2, and OR3 may emit light of the same color (for example, white). In this case, the display device DSP may include a color filter that converts the light emitted from the light emitting layers into light of the color corresponding to the subpixels SP1, SP2, and SP3. In addition, the display device DSP may include a layer including quantum dots that are excited by the light emitted from the light emitting layers to generate the light of the colors corresponding to the subpixels SP1, SP2, and SP3.

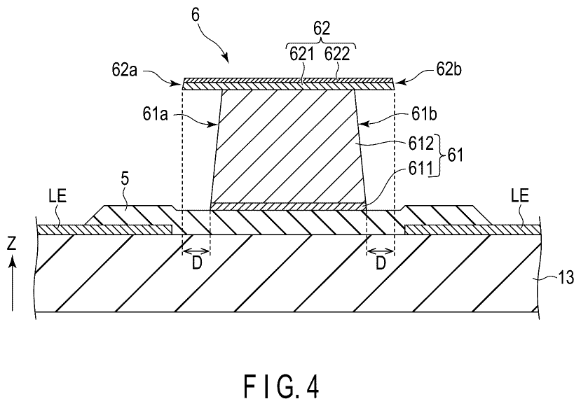

FIG. 4 is an enlarged cross-sectional view schematically showing the partition 6. In FIG. 4, the elements other than the rib 5, the partition 6, the insulating layer 12 and a pair of lower electrodes LE are omitted. The pair of lower electrodes LE correspond to any of the above-described lower electrodes LE1, LE2 or LE3. In addition, the first partition 6x and the second partition 6y described above have the same structure as the partition 6 shown in FIG. 4.

In the example shown in FIG. 4, the lower portion 61 of the partition 6 includes a barrier layer 611 arranged on the rib 5, and a metal layer 612 arranged on the barrier layer 611. The barrier layer 611 corresponds to a bottom portion in the lower portion 61 and is formed of, for example, a metal material such as molybdenum. The metal layer 612 is formed of a metal material different from that of the barrier layer 611 and is formed to be thicker than the barrier layer 611. The metal layer 612 may have a single-layer structure or a multilayer structure of different metal materials. In an example, the metal layer 612 is formed of, for example, aluminum (Al).

The upper portion 62 is thinner than the lower portion 61. In the example shown in FIG. 4, the upper portion 62 includes a lower layer 621 arranged on the metal layer 612, and an upper layer 622 arranged on the lower layer 621. As an example, the lower layer 621 is formed of, for example, titanium (Ti) and the upper layer 622 is formed of, for example, ITO. It has been described that the upper portion 62 has a two-layer stacked structure. However, the upper portion 62 may have a single-layer structure formed of, for example, a metal material such as titanium. In addition, the upper portion 62 may also be formed of a material other than a metal material, and may be formed of an inorganic material such as silicon oxide (SiO). Furthermore, the upper portion 62 may be formed by stacking an appropriate combination of the conductive oxide such as ITO, the metal material such as titanium, and the inorganic material such as silicon oxide, which have been described above, or may be formed of a single layer of any of the above-described materials.

In the example shown in FIG. 4, the width of the lower portion 61 becomes smaller toward the upper portion 62. In other words, the side surfaces 61a and 61b of the lower portion 61 are inclined to the direction Z. The upper portion 62 includes an end portion 62a protruding from the side surface 61a and an end portion 62b protruding from the side surface 61b.

An amount D by which the end portions 62a and 62b protrude from the side surfaces 61a and 61b (hereinafter referred to as an amount of protrusion D of the partition 6) is, for example, 2.0 μm or less. The amount of protrusion D of the partition 6 in the embodiment corresponds to, for example, a length (distance) in the width direction (direction X or direction Y) orthogonal to the direction Z of the partition 6, between a lower end of the side surfaces 61a and 61b (i.e., the end portion of the side surface of the barrier layer 611 on the base 10 side), and the end portions 62a and 62b.

Incidentally, in the example shown in FIG. 4, the side surface of the barrier layer 611 is aligned with the side surface of the metal layer 612 to form a flat surface with no steps. However, the side surface of the barrier layer 611 may retreat slightly with reference to the side surface of the metal layer 612 or protrude toward the side surface of the metal layer 612. In addition, in FIG. 4, the side surfaces of the barrier layer 611 and the metal layer 612 (i.e., the side surfaces 61a and 61b of the lower portion 61) are inclined to the direction Z. However, the side surfaces may be parallel to the direction Z.

It is assumed that the structure of the partition 6 and the materials of each part of the partition 6 can be selected as appropriate in consideration of, for example, a method of forming the partition 6, and the like.

In the embodiment, the partition 6 is formed to divide the subpixels SP in plan view. The above-described organic layer OR is formed by, for example, anisotropic or directional vacuum evaporation. However, when the organic material for forming the organic layer OR is evaporated over the entire base 10 in a state in which the partition 6 is arranged, the organic layer OR is hardly formed on the side surfaces of the partition 6 since the partition 6 has the shape shown in FIG. 3 and FIG. 4. According to this, the organic layer OR (display element 20) which is divided for each subpixel SP by the partition 6 can be formed.

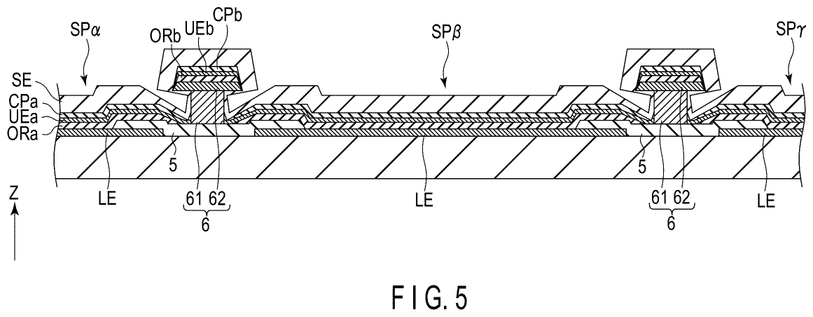

FIG. 5 to FIG. 7 are schematic cross-sectional views illustrating the display element 20 formed using the partition 6. Each of subpixels SPα, SPβ and SPγ shown in FIG. 5 to FIG. 7 corresponds to one of the subpixels SP1, SP2 and SP3.

In a state in which the partition 6 is arranged as described above, the organic layer OR, the upper electrode UE, the cap layer CP, and the sealing layer SE are formed in order on the entire base 10 by vapor deposition as shown in FIG. 5. The organic layer OR includes a light emitting layer which emits light exhibiting a color corresponding to sub-pixel SPα. The partition 6 having an overhang shape divides the organic layer OR into a first organic layer ORa which covers the lower electrode LE and a second organic layer ORb on the partition 6, and divides the upper electrode UE into a first upper electrode UEa which covers the first organic layer ORa and a second upper electrode UEb which covers the second organic layer ORb, and divides the cap layer CP into a first cap layer CPa which covers the first upper electrode UEa and a second cap layer CPb which covers the second upper electrode UEb. The first upper electrode UEa is in contact with the lower portion 61 of the partition 6. The sealing layer SE continuously covers the first cap layer CPa, the partition 6, and the second cap layer CPb.

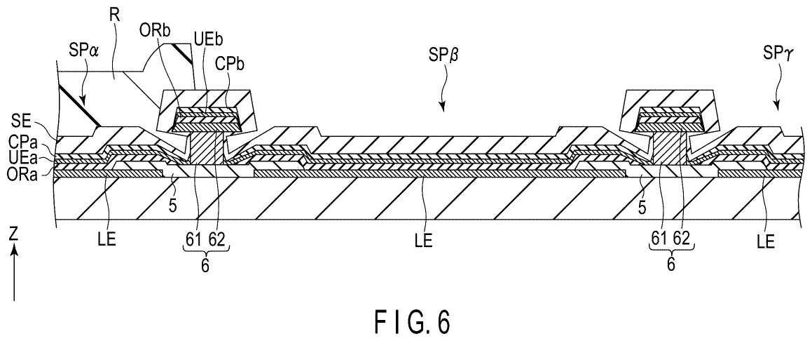

Next, a resist R is formed on the sealing layer SE as shown in FIG. 6. The resist R covers the sub-pixel SPα. In other words, the resist R is arranged directly above the first organic layer ORa, the first upper electrode UEa, and the first cap layer CPa, which are located in the subpixel SPα. The resist R is also located directly above portions close to the subpixel SPα, of the second organic layer ORb, the second upper electrode UEb, and the second cap layer CPb on the partition 6 between the subpixel SPα and the subpixel SPβ. In other words, at least a part of the partition 6 is exposed from the resist R.

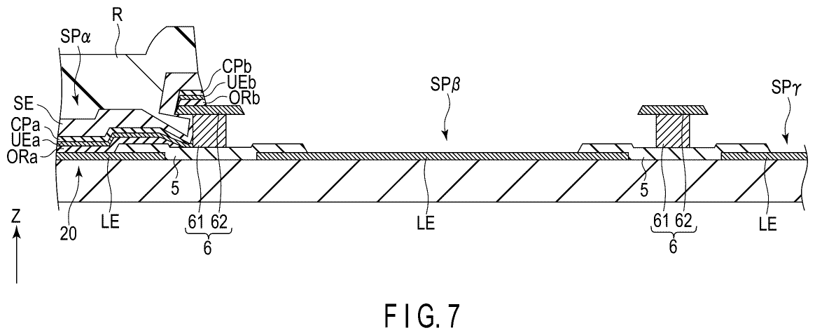

Furthermore, portions exposed from the resist R, of the organic layer OR, the upper electrode UE, the cap layer CP and the sealing layer SE, are removed as shown in FIG. 7, by etching using the resist R as a mask. The display element 20 including the lower electrode LE, the first organic layer ORa, the first upper electrode UEa, and the first cap layer CPa is thereby formed in the subpixel SPα. In contrast, the lower electrode LE is exposed in the subpixels SPβ and SPY. The above-described etching includes, for example, dry etching of the sealing layer SE, wet etching and dry etching of the cap layer CP, wet etching of the upper electrode UE, and dry etching of the organic layer OR.

When the display element 20 of the subpixel SPα is formed as described above, the resist R is removed, and the display elements 20 of the subpixels SPβ and SPγ are formed in order similarly to the subpixel SPα.

The display elements 20 of the subpixels SP1, SP2, and SP3 are formed, and the resin layer 14, the sealing layer 15, and the resin layer 16 are formed, as exemplified for the above subpixels SPα, SPβ and SPY, and the structure of the display device DSP shown in FIG. 3 is thereby implemented.

As described above, the partition 6 includes the lower portion 61 and the upper portion 62 protruding from the side surface of the lower portion 61 but, if the amount of protrusion D (eaves width) of the partition 6 is not appropriate, the reliability of the display device DSP may be reduced.

More specifically, the display device DSP is configured such that the organic layer OR is divided for each subpixel SP by the partition 6 and, if the amount of protrusion D (eaves width) of the partition 6 is not sufficiently larger than the designed value, the organic layer OR may not be able to be appropriately divided. In addition, if the side surface of the lower portion 61 of the partition 6 is covered with the organic layer OR, the electric connection between the lower portion 61 and the upper electrode UE is inhibited. In contrast, the upper electrode UE needs to be in contact with the side surface of the lower portion 61 of the partition 6, in the display device DSP. However, if the amount of protrusion D of the partition 6 exceeds the designed value, the upper electrode UE may not be in contact with the side surface of the lower portion 61.

Furthermore, the appropriate division of the organic layer OR and the electric connection between the lower portion 61 and the upper electrode UE also depend on the length of the lower portion 61 in the direction Z (i.e., the height of the lower portion 61).

More specifically, when the lower portion 61 is higher than needed to the amount of protrusion D of the partition 6, the side surface of the lower portion 61 may be covered with the organic layer OR and the electric connection between the lower portion 61 and the upper electrode UE may be inhibited. In addition, when the height of the lower portion 61 is insufficient to the amount of protrusion D of the partition 6, the organic layer OR may not be able to be appropriately divided.

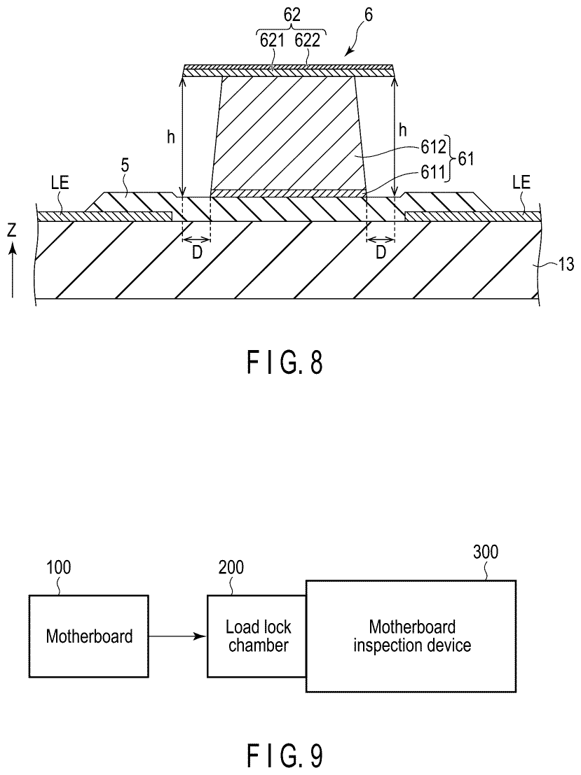

In other words, in the embodiment, the amount of deposition of the organic layer OR (organic semiconductor film) and the upper electrode UE (cathode film) on the lower portion 61 (bottom portion) under the lower portion 61 (eaves) in the vapor deposition is considered to be determined based on the amount of protrusion D of the partition 6 shown in FIG. 8 (i.e., the length from the side surface of the lower portion 61 to the end portion of the upper portion 62 in the direction X or the direction Y) and the height h of the lower portion 61.

For this reason, in order to manufacture the high reliability display device DSP capable of achieving the appropriate division of the organic layer OR and the electric connection between the lower portion 61 and the upper electrode UE, it is useful to measure and manage the amount of protrusion D of the partition 6 and the height h of the lower portion 61, in the process of manufacturing the display device DSP.

In general, however, in the process of manufacturing the display device DSP, a motherboard in which a plurality of display panels are formed on the mother base including a plurality of bases 10 is manufactured, and the display device DSP is manufactured using each of the display panels cut from the motherboard. In order to measure and manage the amount of protrusion D of the partition 6 and the height h of the lower portion 61, however, it is necessary to cut the motherboard and observe the cross-section of the partition 6, which is inefficient.

Incidentally, in the above-described process of manufacturing the display device DSP, a motherboard (array substrate) 100 is inserted into a motherboard inspection device 300 in which a vacuum state is maintained through a load lock chamber 200, and the quality of the motherboard 100 is inspected in the motherboard inspection device 300, as shown in FIG. 9.

In this case, for example, a scanning electron microscopy (SEM) is mounted on the motherboard inspection system 300 and, according to the motherboard inspection system 300, component (element) analysis for the motherboard 100 can be executed by an energy dispersive X-ray spectroscopy (EDX) attached to the SEM.

For this reason, in the embodiment, use of the SEM mounted on the above-described motherboard inspection device 300 for inspection of the inspection device 6 formed on the base 10 is considered.

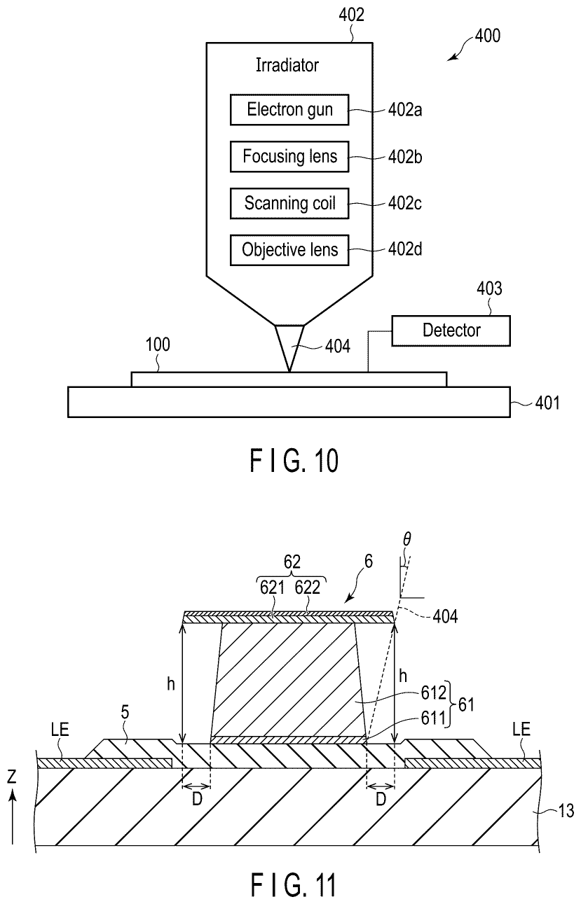

A configuration of the above-described SEM will be simply described with reference to FIG. 10. As shown in FIG. 10, a SEM 400 includes a sample stand 401, an irradiator (emission unit) 402, and a detector 403. In addition, the emission unit 402 includes an electron gun 402a, focusing lens 402b, a scanning coil 402c, and an objective lens 402d.

The electron gun 402a generates an electron beam. The focusing lens 402b and the objective lens 402d focus the electron beam to an electron spot on a sample (in this case, the motherboard 100) placed on the sample stand 401. The irradiator 402 can thereby emit an electron beam 404 containing primary electrons to a sample. The scanning coil 402c scans (moves) an electron spot (i.e., the point of irradiation of the electron beam 404) where the electron beam is focused, on the sample. According to this, secondary electrons are generated from each of the points of irradiation of the electron beam 404, and the generated secondary electrons are detected by the detector 403. The SEM 400 can generate an image of the sample (hereinafter referred to as a SEM image), based on the secondary electrons (i.e., detection data) thus detected by the detector 403. Since the amount of generation of the secondary electrons varies with the irregularity structure on the surface of the sample, the SEM image can be an image which includes a surface shape of the sample. It is known that a SEM image has higher resolution than images captured by, for example, an optical microscope.

Measuring the amount of protrusion D of the partition 6 and the height h of the lower portion 61 using the above-described SEM 400 is assumed. In this case, for example, if it is assumed that the electron beam 404 is emitted toward the partition 6 from the direction Z (i.e., the direction perpendicular to the base 10), a SEM image including the surface shape of the upper surface of the upper portion 62 (i.e., the surface on the direction Z side) is generated and the amount of protrusion D of the partition 6 and the height h of the lower portion 61 cannot be measured from the SEM image since the upper portion 62 of the partition 6 has a larger width than the lower portion 61 (i.e., the shape of the partition 6 is overhung). In other words, for example, if the electron beam 404 is emitted toward the partition 6 from the direction Z, the length of the upper portion 62 of the partition 6 in the direction X or the direction Y can only be measured.

In addition, even if an electron beam 404 is emitted from a side of a surface (i.e., a back surface) opposite to the surface of the side where the display element 20 and the like of the base 10 (motherboard 100) are arranged, only an SEM image including the surface shape of the back surface of the base 10 is generated, and the amount of protrusion D of the partition 6 and the height h of the lower portion 61 cannot be measured.

The amount of deposition of the organic layer OR and the upper electrode UE on the lower portion 61, which gives an influence to the reliability of the display device DSP, is determined based on the amount of protrusion D of the partition 6 and the height h of the lower portion 61 as described above. In order to suppress the degradation in reliability, a ratio of the amount of protrusion D of the partition 6 to the height h of the lower portion 61 (i.e., D/h) is important, but measurement of an absolute value of each of the amount of protrusion D of the partition 6 and the height h of the lower portion 61 is not considered important.

From this viewpoint, tan θ represented using the angle θ inclined from the direction Z shown in FIG. 11 corresponds to the ratio (D/h) of the amount of protrusion D of the partition 6 to the height h of the lower portion 61. Incidentally, the angle θ is an angle formed by a straight line passing at a lower end of the side surface of the lower portion 61 (i.e., the boundary between the rib 5 and the lower portion 61) and the end portion of the upper portion 62 with the direction Z.

Therefore, in the embodiment, an angle θ (hereinafter referred to as a target angle θ) indicating the ratio of the amount of protrusion D of the partition 6 to the height h (length in the direction Z) of the lower portion 61 is measured using the SEM image generated by detecting secondary electrons that occur by emitting electron beams including primary electrons toward the partition 6 from a plurality of oblique directions inclined from the direction Z orthogonal to the base 10.

Incidentally, in the embodiment, it is assumed that the target angle θ is measured by a measuring device which is communicably connected to the SEM 400 mounted on the above-described motherboard inspection system 300. However, the measuring device may be realized as a part of the motherboard inspection device 300 or realized as a device different from the motherboard inspection device 300. Alternatively, the measuring device may also be realized integrally with the SEM 400.

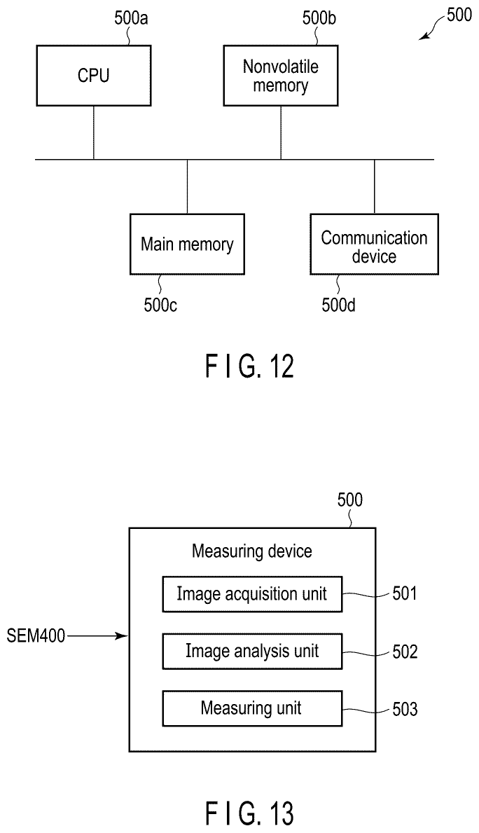

The measuring device of the embodiment will be described below. FIG. 12 shows an example of a hardware configuration of the measuring device.

A measuring device 500 shown in FIG. 12 is realized by, for example, a personal computer and includes a CPU 500a, a nonvolatile memory 500b, a main memory 500c, a communication device 500d, and the like.

The CPU 500a is a processor for controlling the operation of the measuring device 500 and executes various programs that are loaded from the nonvolatile memory 500b into the main memory 500c. The communication device 500d executes communication with external devices (for example, SEM 400, and the like) of the measuring device 500.

FIG. 13 is a view showing an example of a functional configuration of the measuring device 500. As shown in FIG. 13, the measuring device 500 includes an image acquisition unit 501, an image analysis unit 502, and a measuring unit 503.

Some or all of the units 501 to 503 included in the measuring device 500 are realized by the above-described CPU 500a (i.e., the computer of the measuring device 500) executing predetermined programs (i.e., software), but may be realized by hardware such as an integrated circuit (IC) and the like or by a combination of software and hardware.

In the embodiment, the measuring device 500 is communicably connected to the SEM 400, and the image acquisition unit 501 acquires SEM images generated by the SEM 400 from the SEM 400 as described above. The image analysis unit 502 analyzes the SEM images acquired by the image acquisition unit 501. The measuring unit 503 measures the target angle amount θ (i.e., an angle indicating a ratio of the amount of protrusion D of the partition 6 to the height of the lower portion 61), based on the analysis results of the image analyzing unit 502.

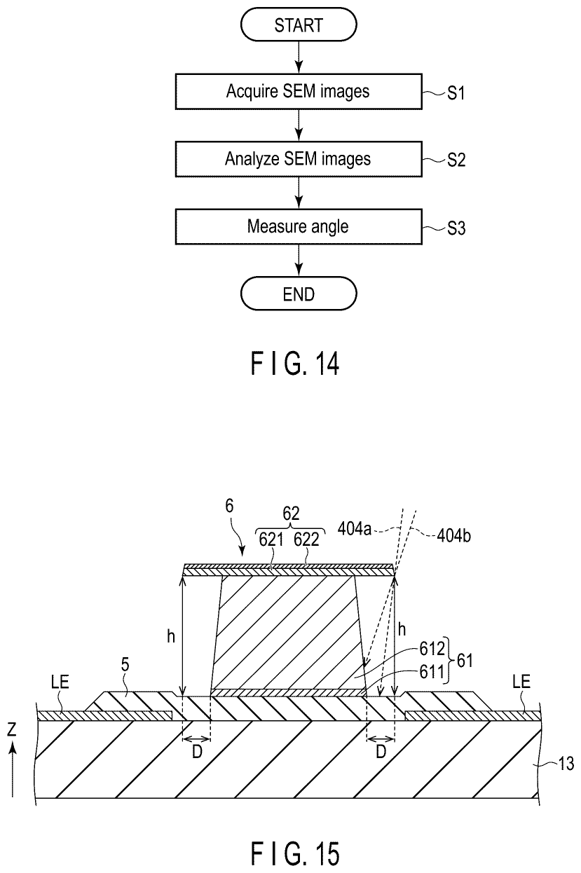

An example of the processing procedure of the measuring device 500 of the embodiment will be described below with reference to a flowchart of FIG. 14.

First, when the motherboard 100 in which the insulating layer 11, the circuit layer 12, the insulating layer 13, the lower electrode LE, the rib 5, and the partition 6 are formed on the motherboard including a plurality of bases 10 is manufactured, the motherboard 100 is inserted into the motherboard inspection device 300 through the load lock chamber 200 shown in FIG. 9. In the motherboard inspection device 300, the SEM 400 generates SEM images and outputs the SEM images to the measurement system 500.

Incidentally, an electron beam is generally emitted from a direction perpendicular to the sample but, in the embodiment, the SEM 400 includes a Tilt function that enables the electron beam 404 to be emitted from an oblique direction to the motherboard 100 (base 10). The Tilt function is realized by mounting, for example, a deflection coil in the irradiator 402 provided in the SEM 400, and generating a magnetic field (magnetic field) with the deflection coil to change the direction of the electron beam 404 emitted (incident) on the motherboard 100 (i.e., to deflect the electron beam 404). The Tilt function is only required to realize making incidence of the electron beam 404 on the motherboard 100 (the partition 6 formed on the mother substrate 100) from an oblique direction. More specifically, the Tilt function may be realized by, for example, inclining the direction of the irradiator 402 provided in the SEM 400 or by, for example, inclining (the motherboard 100 mounted on) the sample stand 401.

Incidentally, in the embodiment, the electron beam 404 is emitted toward the partition 6 while sequentially changing the direction (i.e., the angle to the direction Z) by the above-described Tilt function. Accordingly, the SEM 400 outputs to the measuring device 500 a plurality of SEM images generated by detecting secondary electrons that occur by emitting the electron beam 404 including primary electrons toward the partition 6 from a plurality of oblique directions inclined from the direction (i.e., the direction Z) orthogonal to the motherboard 100 (base 10). In other words, in the embodiment, the plurality of SEM images output from the SEM 400 to the measuring device 500 are considered images including the partition 6 (lower portion 61 and upper portion 62) observed from different angles.

Incidentally, the angle at which the above-described electron beam 404 is emitted may be changed manually or may be changed automatically based on a preset value or the like.

In addition, the SEM 400 recognizes, for example, the angle of the electron beam 404 emitted to the motherboard 100 (base 10) (i.e., the angle formed by the emitting direction of the electron beam 404 with the direction Z) by the Tilt function, and the angle of the electron beam 404 emitted when the SEM images are generated is added to each of the SEM images output from the SEM 400 to the measuring device 500.

Furthermore, in the embodiment, the SEM image (image file) is assumed to be an image of, for example, a file format such as jpeg, but may be a file in any other format.

A plurality of SEM images output from the SEM 400 as described above are acquired by the image acquisition unit 501 in the measuring device 500 (step S1).

Next, the image analysis unit 502 analyzes each of the SEM images acquired in step S1 (step S2).

Incidentally, each of the SEM images acquired in step S1 is composed of a plurality of pixels, and each of the pixels holds a luminance value (pixel value) for displaying the SEM image. In this case, in step S2, a process of specifying an area occupied by the lower portion 61 included in the SEM image, an area occupied by the upper portion 62, an area occupied by the rib 5, and the like is executed based on the luminance value held in each of the plurality of pixels constituting each of the SEM images. In other words, in step S2, it can be specified whether or not (the area occupied by) each of the lower portion 61, the upper portion 62, and the rib 5 is included in the SEM image, by analyzing each of the SEM images.

When the process in step S2 is executed, the measuring unit 503 measures the above-described target angle θ, based on the analysis results of each of the SEM images in step S2 (step S3).

An example of the process in step S3 will be described below. First, FIG. 15 shows an example of the electron beam 404 emitted when the above SEM images are generated. In the example shown in FIG. 15, for example, an electron beam 404a emitted from a direction forming a first angle θ1 with the direction Z, and an electron beam 404b emitted from a direction forming a second angle θ2 larger than the first angle θ1 with the direction Z, are shown.

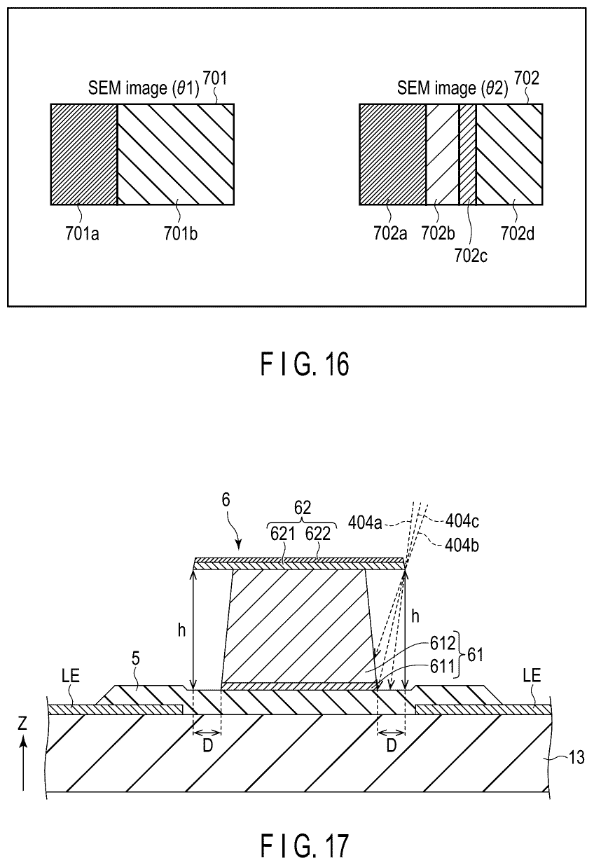

In addition, FIG. 16 shows examples of the SEM images generated by emitting the electron beam 404a and the electron beam 404b. Incidentally, in the embodiment, the SEM images include at least the end portion (for example, the end portion 62b) of the upper portion 62 as shown in FIG. 16.

A SEM image 701 shown in FIG. 16 is a SEM image generated by emitting the electron beam 404a, and includes an area 701a occupied by (the surface opposite to the base 10 of) the upper portion 62 and an area 701b occupied by the rib 5. In other words, the area occupied by the lower portion 61 is not included in the SEM image 701. Incidentally, the first angle θ1 is added to the SEM image 701.

A SEM image 702 shown in FIG. 16 is a SEM image generated by emitting the electron beam 404b, and includes an area 702a occupied by (the surface opposite to the base 10 of) the upper portion 62, an area 702b occupied by the metal layer 612 included in the lower portion 61, an area 702c occupied by the barrier layer 611 included in the lower portion 61, and an area 702d occupied by the rib 5. Incidentally, the second angle θ2 is added to the SEM image 702.

The target angle θ which needs to be measured in the embodiment is, for example, an angle of emission of the electron beam 404 generating the SEM image where the end portion of the upper portion 62 and the lower end of the side surface of the lower portion 61 (i.e., the end portion on the base 10 side) overlap with each other, as shown in FIG. 11.

In contrast, since the SEM image 701 includes only the area 701a occupied by the upper portion 62 and the area 701b occupied by the rib 5 (and does not include the area occupied by the lower portion 61), the target angle θ is estimated to be an angle larger than the first angle θ1 added to the SEM image 701.

In contrast, since the SEM image 702 includes the area 702a occupied by the upper portion 62, the area 702b occupied by the barrier layer 611, the area 702c occupied by the metal layer 612, and the area 702d occupied by the rib 5, the target angle θ is an angle smaller than the second angle θ2 added to the SEM image 702.

According to the SEM image 701 and the SEM image 702, in step S3, for example, an angle larger than the first angle θ1 and smaller than the second angle θ2 can be measured as the target angle θ.

In other words, in the embodiment, for example, if it is specified that the side surface of the lower portion 61 is not included in the SEM image 701, by analyzing the SEM image 701 generated by emitting the electron beam 404a toward the partition 6 from the direction forming the first angle θ1 with the direction Z, and if it is specified that the side surface of the lower portion 61 is included in the SEM image 702, by analyzing the SEM image 702 generated by emitting the electron beam 404b toward the partition 6 from the direction forming the second angle θ2 larger than the first angle θ1 with the direction Z, the angle larger than the first angle θ1 and smaller than the second angle θ2 can be measured as the target angle θ.

In FIG. 16, since only two SEM images 701 and 702 are illustrated for convenience of descriptions, the angle measured as the target angle θ (i.e., the angle larger than the first angle θ1 and smaller than the second angle θ2) may be different from (i.e., may have a large error from) the target angle θ. It is considered that the target angle θ with a higher accuracy can be measured by emitting the electron beam 404 (i.e., acquiring the SEM images) while changing the angle more finely.

In addition, it has been described that the angle larger than the first angle θ1 and smaller than the second angle θ2 is measured as the target angle θ. For example, however, it is assumed that the SEM images are generated by sequentially emitting the electron beams 404a, 404c, and 404b shown in FIG. 17. Incidentally, the electron beam 404a is emitted from the direction forming a first angle θ1 with the direction Z, the electron beam 404c is emitted from the direction forming a third angle θ3 with the direction Z, and the electron beam 404b is emitted from the direction forming a second angle θ2 with the direction Z. Incidentally, the third angle θ3 is an angle larger than the first angle θ1 and smaller than the second angle θ2.

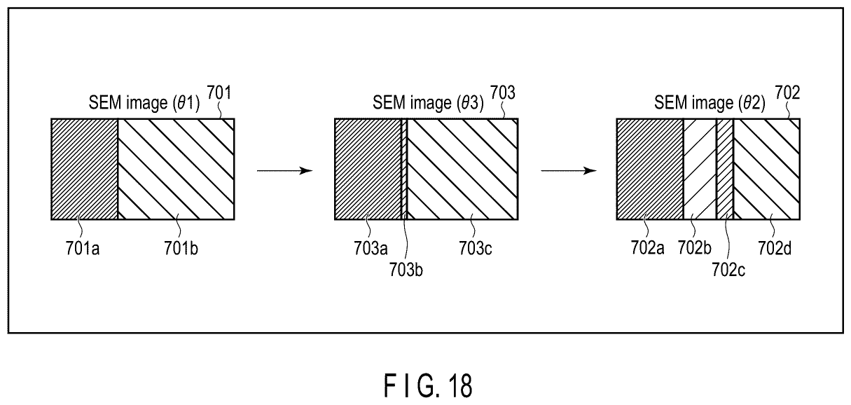

FIG. 18 shows examples of the SEM images generated by sequentially emitting the electron beams 404a, 404c, and 404b. Incidentally, the SEM image 701 generated by emitting the electron beam 404a and the SEM image 702 generated by emitting the electron beam 404b have been described with reference to FIG. 16, and their detailed descriptions are omitted here.

A SEM image 703 shown in FIG. 18 is a SEM image generated by emitting an electron beam 404c, and includes an area 703a occupied by (the surface opposite to the base 10 of) the upper portion 62, an area 703b occupied by the barrier layer 611 included in the lower portion 61, and an area 703c occupied by the rib 5. Incidentally, the third angle θ3 is added to the SEM image 703.

If it is assumed that the electron beams 404a, 404c, and 404b are emitted while changing the angle in order of first angle θ1, third angle θ3, and second angle θ2 as described above to generate (acquire) the SEM images 701, 703, and 702, the area 703b included in the SEM image 703 has an elongated rectangular shape and is considered as a SEM image at timing when the side surface of the lower portion 61 (barrier layer 611) appears. Incidentally, the SEM image at the timing when the side surface of the lower portion 61 appears corresponds to a SEM image generated by emitting the electron beam 404 at an angle (direction) which is larger than the target angle θ, i.e., the angle of the electron beam 404 for generating the SEM image where the end portion of the upper portion 62 and the lower end of the side surface of the lower portion 61 overlap with each other, and which has a small error from the target angle θ.

For this reason, in the embodiment, the angle of emission of the electron beam 404 upon generating the SEM image at the timing when the side surface of the lower portion 61 appears, such as the SEM image shown in FIG. 18, (hereinafter referred to as an angle at appearance of the lower portion 61) may be measured as the target angle θ.

It has been described that the angle at appearance of the lower portion 61 is measured as the target angle θ since it is assumed that the angle of the electron beam 404 is sequentially changed from the first angle θ1 to the second angle θ2. However, when the angle is sequentially changed from the second angle θ2 to the first angle θ1, the angle of emission of the electron beam 404 upon generating the SEM image at the timing when the side surface of the lower portion 61 disappears (hereinafter referred to as an angle at disappearance of the lower portion 61) may be measured as the target angle θ.

The described process of measuring the target angle θ is an example. If the embodiment is configured to measure the target angle θ by analyzing a plurality of SEM generated by emitting the electron beams 404 at different angles, the other measuring process may be executed.

When the target angle θ measured by executing the above-described processes shown in FIG. 14 (i.e., tan θ corresponding to the ratio of the amount of protrusion D of the partition 6 to the height h of the lower portion 61) is appropriate, the display element 20 of each subpixel SP can be formed in the motherboard 100 as described above with reference to FIG. 5 to FIG. 7.

Incidentally, measuring the target angle θ at a part the partition 6 formed on the motherboard 100 has been described with reference to FIG. 14. However, the process shown in FIG. 14 may be executed a plurality of times to measure the target angle θ at a plurality of parts of the partition 6.

According to the embodiment, as described above, the partition 6 including the lower portion 61 provided on the base 10 (motherboard) and the upper portion 62 protruding from the side surface of the lower portion 61 is formed, a plurality of SEM images generated by detecting secondary electrons that occur by emitting the electron beams 404 including the primary electrons toward the partition 6 from a plurality of oblique directions (second directions) inclined from the Z direction (first direction) orthogonal to the base 10 are acquired, the acquired plurality of SEM images are analyzed, and the target angle θ (i.e., the first angle indicating the ratio of the amount of protrusion D at which the end portion of the upper portion 62 protrudes from the side surface of the lower portion 61 to the length of the lower portion 61 in the direction Z) is measured based on the analysis result.

In the embodiment, with the above-described configuration, since the display device DSP can be manufactured in which the ratio of the amount of protrusion D of the partition 6 to the height h of the lower portion 61 is appropriate (i.e., the partition 6 is appropriately formed), the degradation in reliability of the display device DSP can be suppressed.

In addition, since the embodiment is configured to measure the target angle θ using the SEM 400 mounted on the motherboard inspection device 300 used to inspect the quality of the motherboard 100, continuous flow inspection using existing installations can be realized.

Incidentally, in the embodiment, each of the plurality of SEM images desirably includes the end portion of the upper portion 62, and the target angle θ desirably matches the angle of emission of the electron beam 404 (i.e., the angle which the direction of emission of the electron beam 404 forms with the direction Z) so as to generate the SEM image where the end portion of the upper portion 62 and the end portion on the base 10 side (i.e., the lower end) of the side surface of the lower portion 61 overlap with each other.

In this case, in the embodiment, as described in FIG. 15 and FIG. 16, for example, it is possible to acquire the SEM image 701 generated by emitting the electron beam 404a and the SEM image 702 generated by emitting the electron beam 404b, and measure the angle which is larger than the first angle θ1 (second angle) and smaller than the second angle θ2 (third angle) as the target angle θ if it is specified that (the area occupied by) the side surface of the lower portion 61 is not included in the SEM image 701 and that (the areas 702b and 702c occupied by) the side surface of the lower portion 61 is included in the SEM image 702.

Incidentally, in the embodiment, the angle formed by the direction of emitting the electron beam 404 with the direction Z (i.e., the angle at appearance or disappearance of the lower portion 61) upon generating the SEM image (first image) at the timing when the side surface of the lower portion 61 appears and the SEM image (second image) at the timing when the side surface of the lower portion 61 disappears, among the plurality of SEM images generated by emitting the electron beam 404 from a plurality of oblique directions toward the partition 6 while sequentially changing the angle as described above, may be measured as the target angle θ.

In addition, in the embodiment, for example, it is assumed that the target angle θ measured as described above is output (transmitted, displayed, or the like) from the measuring device 500 to present the target angle θ (or tan θ) to a manager of the process of manufacturing the display device DSP, or the like. However, the measuring device 500 may include a function of automatically determining whether or not the partition 6 is appropriately formed based on the target angle θ (or tan θ) (hereinafter referred to as a determining function). According to this determination function, it is determined that the partition 6 is appropriately formed if the target angle θ is within a predetermined range. Incidentally, if it is determined that the partition 6 is appropriately formed, the display element 20 (organic layer OR, upper electrode UE, and the like) of each subpixel SP may be formed as described above.

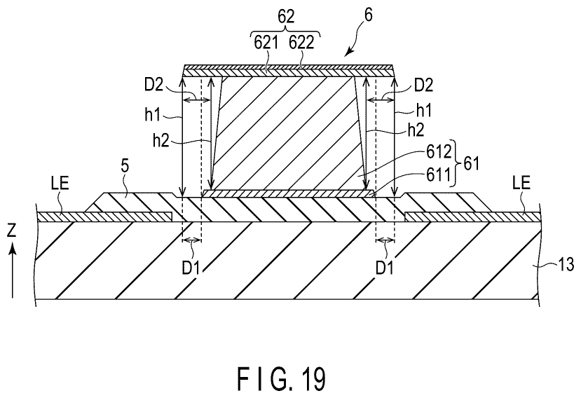

Incidentally, in the embodiment, it has been mainly described that the side surface of the barrier layer 611 (first layer) and the side surface of the metal layer 612 (second layer) are aligned to form a flat surface with no steps as described with reference to FIG. 4. For example, however, if the partition 6 is formed such that the side surface of the barrier layer 611 protrudes toward the side surface of the metal layer 612 as shown in FIG. 19, the target angle θ (hereinafter referred to as a first target angle θ) indicating the ratio of the amount of protrusion D1 at which the end portion of the upper portion 62 protrudes from (the end portion of the base 10 side of) the side surface of the barrier layer 611 to the height h1 of the lower portion 61 (barrier layer 611 and metal layer 612) may be measured, or the target angle θ (hereinafter referred to as a second target angle θ) indicating the ratio of the amount of protrusion D2 at which the end portion of the upper portion 62 protrudes from (the end portion of the base 10 side of) the side surface of the metal layer 612 to the height h2 of the metal layer 612 may be measured.

Incidentally, in the embodiment, at least one of the first and second target angles θ may be measured. However, if both the first and second target angles θ are measured, the display device DSP in which both the first and second target angles θ are appropriate (i.e., the display device DSP with higher reliability) can be manufactured.

Incidentally, in a case where both the first and second target angles θ are measured in the configuration in which the measuring device 500 according to the embodiment includes the above-described determining function, if the first target angle θ is within a predetermined first range and the second target angle θ is within a predetermined second range (i.e., both the first and second target angles θ are appropriate), it is determined that the partition 6 is appropriately formed. However, for example, if the first target angle θ is within the first range or the second target angle θ is within the second range (i.e., at least one of the first and second target angles θ is appropriate), it may be determined that the partition 6 is appropriately formed. In this case, the first range and the second range may be different ranges or the same ranges.

All measuring methods and measuring devices, which are implementable with arbitrary changes in design by a person of ordinary skill in the art based on the measuring methods and measuring devices described above as the embodiments of the present invention, belong to the scope of the present invention as long as they encompass the spirit of the present invention.

Various modifications are easily conceivable within the category of the idea of the present invention by a person of ordinary skill in the art, and these modifications are also considered to belong to the scope of the present invention. For example, additions, deletions or changes in design of the constituent elements or additions, omissions or changes in condition of the processes may be arbitrarily made to the above embodiments by a person of ordinary skill in the art, and these modifications also fall within the scope of the present invention as long as they encompass the spirit of the present invention.

In addition, the other advantages of the aspects described in the above embodiments, which are obvious from the descriptions of the specification or which are arbitrarily conceivable by a person of ordinary skill in the art, are considered to be achievable by the present invention as a matter of course.

What is claimed is:

1. A measuring method comprising:
forming a partition including a lower portion provided on a base and an upper portion protruding from a side surface of the lower portion;
acquiring a plurality of images generated by detecting secondary electrons that occur by emitting electron beams including primary electrons toward the partition from a plurality of second directions inclined from a first direction orthogonal to the base;
analyzing the acquired plurality of images; and
measuring a first angle for indicating a ratio of an amount of protrusion at which an end portion of the upper portion protrudes from the side surface of the lower portion to a length of the lower portion in the first direction, based on a result of the analysis.

2. The measuring method of claim 1, wherein
each of the plurality of images includes an end portion of the upper portion.

3. The measuring method of claim 2, wherein
the acquiring includes acquiring a first image generated by detecting secondary electrons that occur by emitting the electron beam toward the partition from a second direction forming a second angle with the first direction, and acquiring a second image generated by detecting secondary electrons that occur by emitting the electron beam toward the partition from the second direction forming a third angle larger than the second angle with the first direction, and
the measuring includes measuring an angle larger than the second angle and smaller than the third angle as the first angle if it is specified that the side surface of the lower portion is not included in the first image by analyzing the first image and if it is specified that the side surface of the lower portion is included in the second image by analyzing the second image.

4. The measuring method of claim 2, wherein
the electron beam is emitted toward the partition from a second direction forming the angle while sequentially changing an angle with the first direction, and
the measuring includes measuring an angle which a second direction forms with the first direction as the first angle by analyzing each of the plurality of images, the second direction being a direction for emitting the electron beams when generating a first image at timing when a side surface of the lower portion appears or a second image at timing when the side surface of the lower portion disappears, among the plurality of images.

5. The measuring method of claim 1, wherein
the lower portion includes a first layer provided on the base and a second layer provided on the first layer, and
the measuring includes measuring a first angle for indicating at least one of a ratio of an amount of protrusion at which an end portion of the upper portion protrudes from a side surface of the first layer to lengths of the first and second layers in the first direction, and a ratio of an amount of protrusion at which the end portion of the upper portion protrudes from a side surface of the second layer to the length of the second layer in the first direction, based on the result of the analysis.

6. The measuring method of claim 5, wherein
the first and second layers are formed of different metal materials.

7. The measuring method of claim 1, further comprising:
determining whether the partition is appropriately formed, based on the measured first angle.

8. The measuring method of claim 7, further comprising:
forming a lower electrode on the base; and
forming a rib which covers a part of the lower electrode and which includes an aperture overlapping with the lower electrode, wherein
the partition is formed on the rib.

9. The measuring method of claim 8, further comprising:
forming an organic layer which is in contact with the lower electrode through the aperture if it is determined that the partition is appropriately formed; and
forming an upper electrode on the organic layer.

10. A measuring device comprising:
an acquisition unit configured to acquire a plurality of images generated by detecting secondary electrons that occur by emitting electron beams including primary electrons toward a partition from a plurality of second directions inclined from a first direction orthogonal to the base where the partition including a lower portion and an upper portion protruding from a side surface of the lower portion is formed;
an analysis unit configured to analyze the plurality of images acquired; and
a measuring unit configured to measure a first angle for indicating a ratio of an amount of protrusion at which an end portion of the upper portion protrudes from the side surface of the lower portion to a length of the lower portion in the first direction, based on a result of the analysis.

11. The measuring device of claim 10, wherein
each of the plurality of images includes an end portion of the upper portion.

12. The measuring device of claim 11, wherein
the acquisition unit is configured to acquire a first image generated by detecting secondary electrons that occur by emitting the electron beam toward the partition from a second direction forming a second angle with the first direction, and acquire a second image generated by detecting secondary electrons that occur by emitting the electron beam toward the partition from the second direction forming a third angle larger than the second angle with the first direction, and
the measuring unit is configured to, if it is specified that the side surface of the lower portion is not included in the first image by analyzing the first image and if it is specified that the side surface of the lower portion is included in the second image by analyzing the second image, measure an angle larger than the second angle and smaller than the third angle as the first angle.

13. The measuring device of claim 11, wherein
the electron beam is emitted toward the partition from a second direction forming the angle while sequentially changing an angle with the first direction, and
the measuring unit is configured to measure an angle which a second direction forms with the first direction as the first angle by analyzing each of the plurality of images, the second direction being a direction for emitting the electron beams when generating a first image at timing when the side surface of the lower portion appears or a second image at timing when the side surface of the lower portion disappears, among the plurality of images.

14. The measuring device of claim 10, wherein
the lower portion includes a first layer provided on the base and a second layer provided on the first layer, and
the measuring unit is configured to measure a first angle for indicating at least one of a ratio of an amount of protrusion at which an end portion of the upper portion protrudes from a side surface of the first layer to lengths of the first and second layers in the first direction, and a ratio of an amount of protrusion at which the end portion of the upper portion protrudes from a side surface of the second layer to the length of the second layer in the first direction, based on the result of the analysis.

15. The measuring device of claim 14, wherein
the first and second layers are formed of different metal materials.

16. The measuring device of claim 10, further comprising:
a determining unit configured to determine whether the partition is appropriately formed, based on the measured first angle.

17. The measuring device of claim 16, wherein
a lower electrode is formed on the base,
a rib which covers a part of the lower electrode and which includes an aperture overlapping with the lower electrode is formed, and
the partition is formed on the rib.

18. The measuring device of claim 17, wherein
if it is determined that the partition is appropriately formed, an organic layer which is in contact with the lower electrode through the aperture is formed and an upper electrode is formed on the organic layer.

19. The measuring device of claim 10, further comprising:
an irradiator configured to emit the electron beam; and
a detector configured to detect the secondary electrons that occur by emitting the electron beam toward the partition.
